(19) United States
(12) Patent Application Publication
(10) Pub. No.: US 2024/0136538 A1
(43) Pub. Date: Apr. 25, 2024

(54) IONOMER FOR HIGH-TEMPERATURE POLYMER ELECTROLYTE MEMBRANE FUEL CELL

(71) Applicants: Hyundai Motor Company, Seoul (KR); Kia Corporation, Seoul (KR); Gwangju Institute of Science and Technology, Gwangju (KR)

(72) Inventors: Won Jae Choi, Seoul (KR); Songi Oh, Suwon (KR); Da Hee Kwak, Suwon (KR); Ji Hoon Jang, Suwon (KR); Sung Hee Shin, Incheon (KR); Jae Suk Lee, Gwangju (KR); Hye Min Oh, Gwangju (KR); In Gyu Bak, Gwangju (KR)

(21) Appl. No.: 18/085,151

(22) Filed: Dec. 20, 2022

(30) Foreign Application Priority Data
Oct. 5, 2022 (KR) 10-2022-0127064

(51) Int. Cl. H01M 4/86; C08G 65/40; C08G 65/48

(52) U.S. Cl. CPC H01M 4/8668; C08G 65/40; C08G 65/48; H01M 2008/1095

(57) ABSTRACT

Disclosed is an ionomer for a high-temperature polymer electrolyte membrane fuel cell, which includes a phosphorus (P)-containing functional group having proton conductivity and partially contains fluorine in the main chain thereof.

### CROSS-REFERENCE TO RELATED APPLICATION

This application claims, under 35 U.S.C. § 119(a), the benefit of priority from Korean Patent Application No. 10-2022-0127064, filed on Oct. 5, 2022, the entire contents of which are incorporated herein by reference.

### TECHNICAL FIELD

The present disclosure relates to an ionomer for a high-temperature polymer electrolyte membrane fuel cell. The ionomer may include a phosphorus (P)-containing functional group having proton conductivity and partially containing fluorine in the main chain thereof.

### BACKGROUND

A high-temperature polymer electrolyte membrane fuel cell operating at high temperatures of 160° C. or greater is used in a dry environment without water. Therefore, as a binder for electrodes, Nafion, and the like for the existing low-temperature polymer electrolyte membrane fuel cell cannot be used. Polytetrafluoroethylene (PTFE), polyvinylidene fluoride (PVDF), and the like having high thermal stability, are used as binders for electrodes of high-temperature polymer electrolyte membrane fuel cells, but they do not have proton conductivity, which is undesirable.

In order to improve electrode performance of the high-temperature polymer electrolyte membrane fuel cell, it is necessary to introduce an ionomer capable of transporting protons. However, since a material having proton conductivity is structurally hydrophilic, it may cause electrode poisoning and performance degradation by the generated water and phosphoric acid electrolyte of the high-temperature polymer electrolyte membrane fuel cell.

Accordingly, there is a great need for a novel ionomer that has proton conductivity, has high thermal stability, does not lose proton conductivity under dry conditions, and is resistant to acid.

### SUMMARY

In preferred aspects, provided is an ionomer capable of improving performance of a high-temperature polymer electrolyte membrane fuel cell.

The term “ionomer” as used herein refers to a polymeric material or resin that includes ionized groups attached (e.g., covalently bonded) to the backbone of the polymer as pendant groups. Preferably, such ionized groups may be functionalized to have ionic characteristics, e.g., cationic or anionic. In certain embodiments, the ionic characteristics may be implemented by phosphorus (P)-containing functional groups, e.g., phosphate group (e.g., —P(OH)₂(O)) or a phosphonate group (e.g., —P(OR)₂(O)).

The objects of the present disclosure are not limited to the foregoing. The objects of the present disclosure will be able to be clearly understood through the following description and to be realized by the means described in the claims and combinations thereof.

In an aspect, provided is an ionomer for a high-temperature polymer electrolyte membrane fuel cell, which may include a copolymer of a first repeat unit represented by Chemical Formula 1,

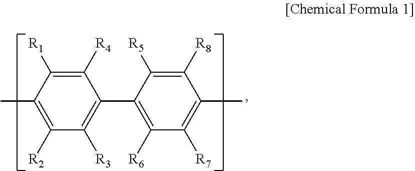

wherein each of R₁ to R₈ is independently hydrogen or fluorine (F), and
a second repeat unit represented by Chemical Formula 2,

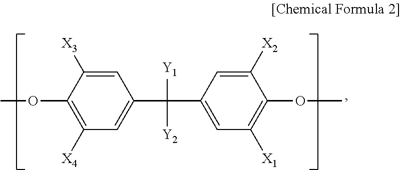

wherein each of X₁ to X₄ is independently hydrogen, an alkyl group having 1 to 4 carbon atoms, or a phosphorus (P)-containing functional group, and each of Y₁ and Y₂ is independently hydrogen or an alkyl group having 1 to 4 carbon atoms.

The copolymer may be an alternating copolymer, a random copolymer, or a block copolymer.

The copolymer may have a weight average molecular weight of about 30,000 g/mol to 100,000 g/mol.

The phosphorus (P)-containing functional group may include a phosphate group, a phosphonate group, or combinations thereof.

The copolymer may be represented by Chemical Formula 3,

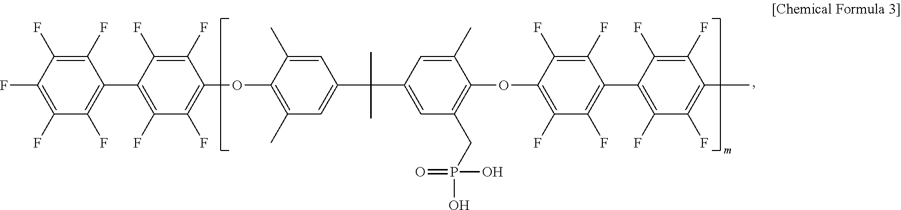

wherein m is an integer from 40 to 140.

The copolymer may be represented by Chemical Formula 4 below,

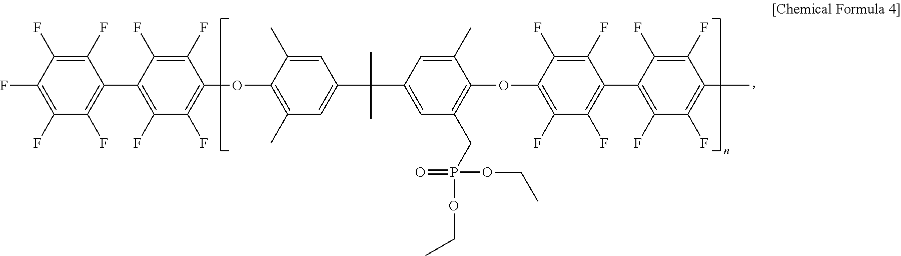

wherein n is an integer of 40 to 140.

The compound may satisfy Relation 1,

$$28 \% \leq \frac{\begin{matrix}number of {X}_{1} to {X}_{4} \\ substituted with phosphorus \\ ( P ) - containing functional \\ group in copolymer\end{matrix}}{\begin{matrix}total number of \\ {X}_{1} to {X}_{4} contained \\ in copolymer\end{matrix}} \times 100 < 86 \% . \qquad [ Relation 1 ]$$

In an aspect, provided is a high-temperature polymer electrolyte membrane fuel cell (“fuel cell”), including an electrolyte membrane, a cathode disposed on one surface of the electrolyte membrane, and an anode disposed on the remaining surface of the electrolyte membrane. Particularly, the cathode includes the ionomer described above.

In an aspect, provided is a method of preparing an ionomer for a high-temperature polymer electrolyte membrane fuel cell. The method includes steps of: preparing a first precursor compound represented by Chemical Formula 7 below, preparing a second precursor compound in which at least one of X₅ to X₈ is substituted with elemental bromine by reacting the first precursor compound with a compound containing elemental bromine, and substituting the elemental bromine with a phosphorus (P)-containing functional group by reacting the second precursor compound with a compound containing elemental phosphorus.

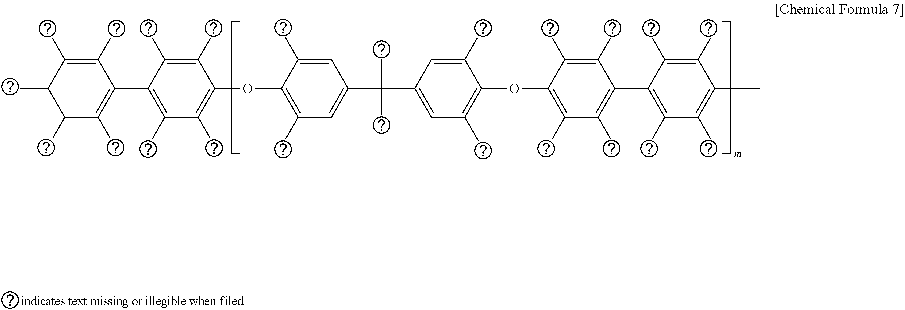

In Chemical Formula 7, each of R₁ to R₁₇ is independently hydrogen or fluorine (F), each of Y₁ and Y₂ is independently hydrogen or an alkyl group having 1 to 4 carbon atoms, each of X 5 to X₈ is independently hydrogen or an alkyl group having 1 to 4 carbon atoms, and m is an integer from 40 to 140.

The compound containing elemental bromine may include N-bromosuccinimide.

The compound containing elemental phosphorus may include triethyl phosphite.

The ionomer may include a copolymer represented by Chemical Formula 4 below.

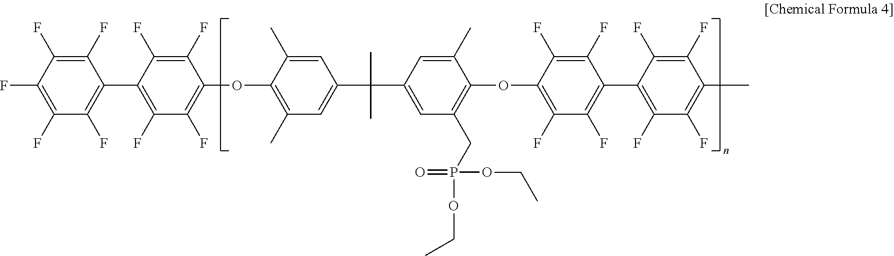

In Chemical Formula 4, n is an integer from 40 to 140.

A copolymer represented by Chemical Formula 3 below may be obtained by adding an acid solution to the copolymer represented by Chemical Formula 4 and then performing heat treatment.

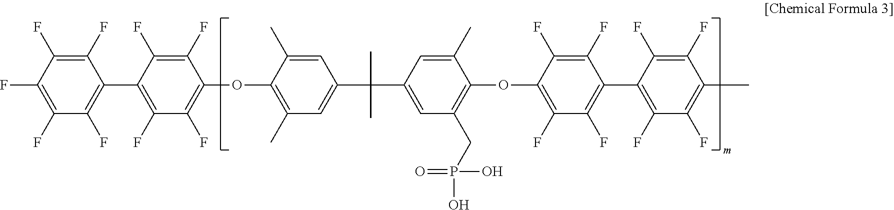

In Chemical Formula 3, m is an integer from 40 to 140.

The thus prepared copolymer satisfies Relation 1

$$28 \% \leq \frac{\begin{matrix}nmber of {X}_{1} to {X}_{4} \\ substituted with phosphorus \\ ( P ) - containing functional \\ group in copolymer\end{matrix}}{\begin{matrix}total number of \\ {X}_{1} to {X}_{4} contained \\ in copolymer\end{matrix}} \times 100 < 86 \% . \qquad [ Relation 1 ]$$

In another aspect, provided is a vehicle including the fuel cell as described herein.

Other aspect of the invention are disclosed infra.

### BRIEF DESCRIPTION OF THE DRAWINGS

The above and other features of the present disclosure will now be described in detail with reference to certain exemplary embodiments thereof illustrated in the accompanying drawings, which are given hereinbelow by way of illustration only, and thus are not limitative of the present disclosure, and wherein:

FIG. 1 shows a cross-sectional view of an exemplary high-temperature polymer electrolyte membrane fuel cell according to an exemplary embodiment of the present disclosure;

FIG. 2 shows results of NMR analysis of FPAE according to Preparation Example 3;

FIG. 3 shows results of NMR analysis of BFPAE according to Preparation Example 3;

FIG. 4 shows results of NMR analysis of FPAE-PN according to Preparation Example 3;

FIG. 5 shows results of NMR analysis of FPAE-PA according to Preparation Example 3;

FIG. 6A shows a voltage-current density graph of high-temperature polymer electrolyte membrane fuel cells according to Examples 1 to 3 and Comparative Examples 1 and 2;

FIG. 6B is a Nyquist diagram showing the impedance results of the high-temperature polymer electrolyte membrane fuel cells according to Examples 1 to 3 and Comparative Examples 1 and 2;

FIG. 7A shows a voltage-current density graph of high-temperature polymer electrolyte membrane fuel cells according to Examples 4 and 5 and Comparative Examples 3 and 4; and

FIG. 7B is a Nyquist diagram showing the impedance results of the high-temperature polymer electrolyte membrane fuel cells according to Examples 4 and 5 and Comparative Examples 3 and 4.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

In general, a vehicle including a fuel cell (hereinafter referred to as a “fuel cell vehicle”) requires various levels of power from the fuel cell. When a relatively high level of power is required from the fuel cell, the volume of the fuel cell mounted within the vehicle may increase. As a result, the amount of space occupied by the fuel cell in the fuel cell vehicle increases, which may cause various problems.

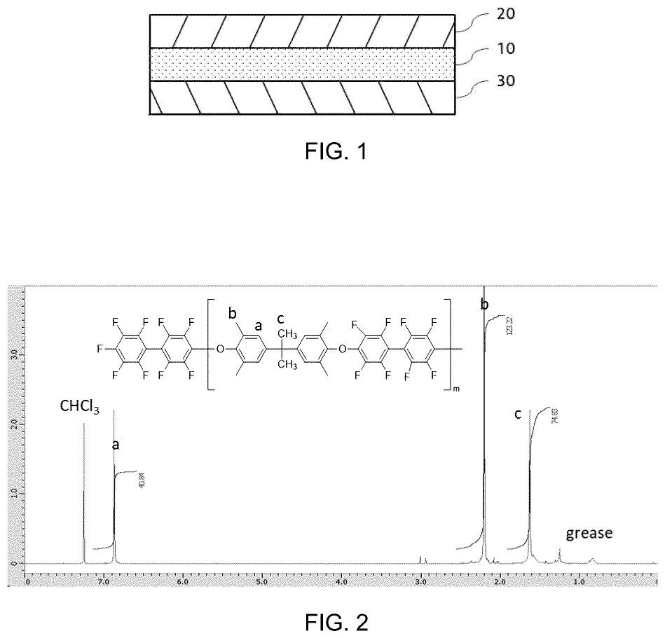

FIG. 1 shows a cross-sectional view of an exemplary high-temperature polymer electrolyte membrane fuel cell according to an exemplary embodiment of the present disclosure. With reference thereto, the high-temperature polymer electrolyte membrane fuel cell may include an electrolyte membrane 10, a cathode 20 disposed on one surface of the electrolyte membrane 10, and an anode 30 disposed on the remaining surface of the electrolyte membrane 10.

The electrolyte membrane 10 may include any material commonly used in the technical field to which the present disclosure belongs. For example, the electrolyte membrane 10 may include polybenzimidazole (PBI) to which phosphoric acid is added.

The cathode 20 and the anode 30 may include a catalyst and an ionomer.

The catalyst may include any material commonly used in the technical field to which the present disclosure belongs. Examples thereof may include a noble metal catalyst such as platinum (Pt), a non-noble metal catalyst, an alloy catalyst thereof, and the like.

The ionomer may include a copolymer obtained by copolymerizing a first repeat unit represented by Chemical Formula 1 below and a second repeat unit represented by Chemical Formula 2 below,

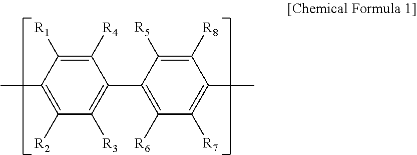

wherein each of R₁ to R₈ is independently hydrogen or fluorine (F), at least one of R₁ to R₈ including fluorine (F),

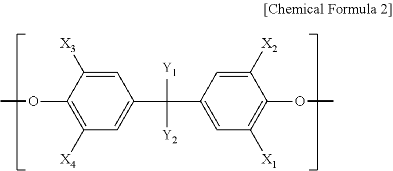

wherein each of X₁ to X₄ is independently hydrogen, an alkyl group having 1 to 4 carbon atoms, or a phosphorus (P)-containing functional group. Also, at least one of X₁ to X₄ may include a phosphorus (P)-containing functional group.

Each of Y₁ and Y₂ may include hydrogen or an alkyl group having 1 to 4 carbon atoms.

The copolymer may include an alternating copolymer, a random copolymer, or a block copolymer of the first repeat unit and the second repeat unit.

The copolymer may have a weight average molecular weight of about 30,000 g/mol to 100,000 g/mol. When the weight average molecular weight of the compound is greater than about 100,000 g/mol, solubility may decrease, whereas when it is less than about 30,000 g/mol, the compound may be difficult to deposit on the electrode.

The ionomer according to the present disclosure is characterized in that fluorine (F) is introduced into the first repeat unit. The introduction of fluorine (F) increases hydrophobicity of the ionomer, thereby facilitating treatment of excessively generated water and phosphoric acid, which are problematic at the cathode 20, and increasing chemical stability in an acid atmosphere and under high-temperature conditions. This leads to reduced catalyst poisoning, and consequently, it is of great help in improving electrode performance of high-temperature polymer electrolyte membrane fuel cells.

The phosphorus (P)-containing functional group may be a functional group for proton conduction. The phosphorus (P)-containing functional group may include at least one selected from the group consisting of a phosphate group, a phosphonate group, and combinations thereof.

The phosphate group may be represented by Chemical Formula 5 below,

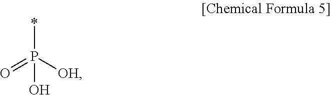 [SMILES: *P(=O)(O)O]

wherein * represents a connection point with the main chain.

The phosphonate group may be represented by Chemical Formula 6 below,

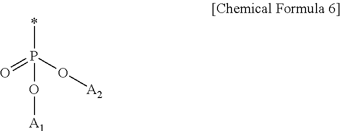

wherein * represents a connection point with the main chain. Each of A₁ and A₂ is independently an alkyl group or an aryl group.

The ionomer according to the present disclosure is characterized in that a phosphorus (P)-containing functional group having proton conductivity is introduced into the second repeat unit. In particular, by appropriately adjusting the proportion of introduction of the phosphorus (P)-containing functional group, proton conductivity and chemical stability may be increased in a balanced manner. The compound may satisfy Relation 1 below.

$$28 \% \leq \frac{\begin{matrix}number of {X}_{1} to {X}_{4} \\ substituted with phosphorus \\ ( P ) - containing functional \\ group in copolymer\end{matrix}}{\begin{matrix}total number of \\ {X}_{1} to {X}_{4} contained \\ in copolymer\end{matrix}} \times 100 < 86 \% \qquad [ Relation 1 ]$$

The copolymer may be obtained in a manner in which a polymer therefor may be synthesized and then subjected to bromination such that any one of X₁ to X₄ in the second repeat unit is substituted with bromine (Br), followed by substitution of bromine (Br) with a phosphorus (P)-containing functional group. Briefly, the proportion of introduction of bromine (Br) may be substantially the same as the proportion of introduction of the phosphorus (P)-containing functional group. Relation 1 can be said to express the degree of bromination of the compound differently. The degree of bromination of the compound may be analyzed through NMR spectroscopy.

When the proportion of introduction of the phosphorus (P)-containing functional group in the compound is less than about 28%, proton conductivity of the ionomer may be less, whereas when it is about 86% or greater, the effect of introduction of fluorine (F) may be deteriorated due to increased hydrophilicity of the ionomer.

The compound is preferably represented by Chemical Formula 3 below,

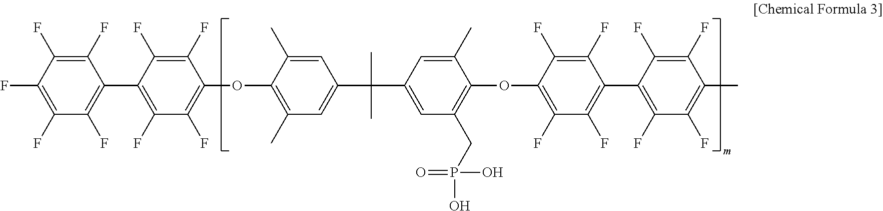

wherein m is an integer of 40 to 140.

The compound is preferably represented by Chemical Formula 4 below,

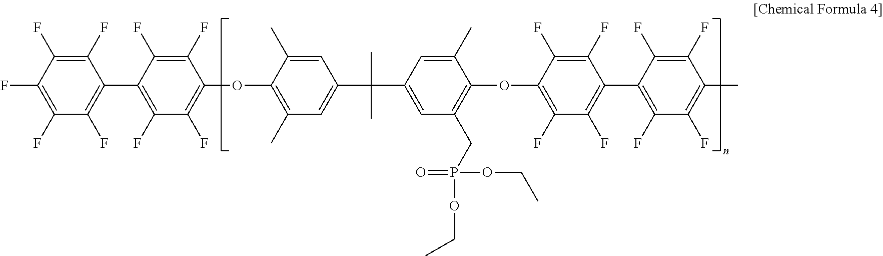

wherein n is an integer of 40 to 140.

### EXAMPLE

A better understanding of the present disclosure may be obtained through the following examples. These examples are merely set forth to illustrate the present disclosure, and are not to be construed as limiting the scope of the present disclosure.

### Preparation Examples 1 to 3 and Comparative Preparation Example 1

### 1. Synthesis of Partially Fluorinated Poly(Arylene Ether) (FPAE)

Partially fluorinated poly(arylene ether) (FPAE) was synthesized through the following reaction mechanism using components in the amounts shown in Table 1 below.

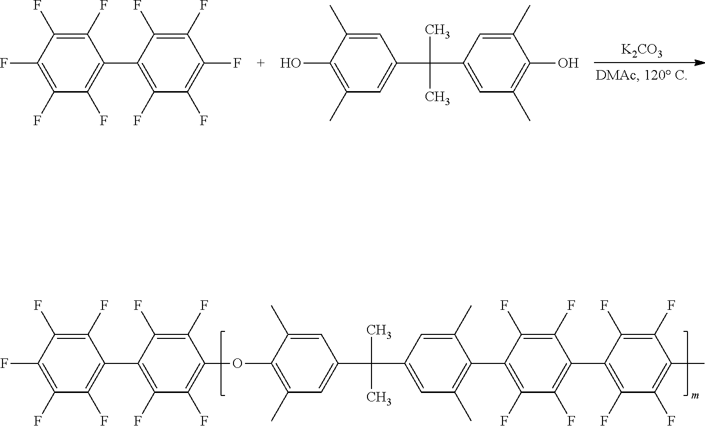

A specific preparation method was as follows.
(1) A reactor temperature was set to 60° C. and a condenser was prepared.
(2) TMBP (2,2-bis(4-hydroxy-3,5-dimethylphenyl)propane) and K₂CO₃ were placed in a 2-neck flask.
(3) A Dean flask was connected thereto and benzene was placed in the Dean flask.
(4) DMAc and benzene were sequentially placed in the 2-neck flask.
(5) Reaction was carried out for 1 hour and 30 minutes under nitrogen purging.
(6) DFBP (decafluorobiphenyl) was added thereto and reaction was carried out for 3 hours and 30 minutes under nitrogen purging.

(7) The product was precipitated in ethanol, filtered, and then dried.

(8) The result was dissolved in chloroform, reprecipitated in ethanol, filtered, and then dried to obtain partially fluorinated poly(arylene ether) (FPAE).

The amounts of components that were used and the properties of the product are shown in Table 1 below.

TABLE 1

| | Comparative | | | | | | | |
|---|---|---|---|---|---|---|---|---|
| | Preparation | | Preparation | | Preparation | | Preparation | |
| Items | Example 1 | | Example 1 | | Example 2 | | Example 3 | |
| TMBP [g(mmol)] | 5.68 | (20) | 2.84 | (10) | 5.68 | (20) | 2.84 | (10) |
| K₂CO₃ [g(mmol)] | 3.46 | (25.0) | 1.73 | (12.5) | 3.46 | (25.0) | 1.73 | (12.5) |
| DMBP [g(mmol)] | 6.75 | (20.2) | 3.37 | (10.1) | 6.75 | (20.2) | 3.37 | (10.1) |

| | | | | |
|---|---|---|---|---|
| DMAc [ml] | 106 | 53.0 | 106 | 53.0 |
| Benzene [ml] | 21.2 | 10.6 | 21.2 | 10.6 |
| FPAE weight [g] | 9.36 | 6.60 | 6.0 | 3.80 |
| FPAE yield [%] | 81 | 94 | 52 | 66 |
| FPAE molecular weight [kDa] | 38.8 | 52.0 | 46.9 | 30.5 |

### 2. Synthesis of Bromine-Containing Partially Fluorinated Poly(Arylene Ether) (BFPAE)

BFPAE was synthesized through the following reaction mechanism using components in the amounts shown in Table 2 below.

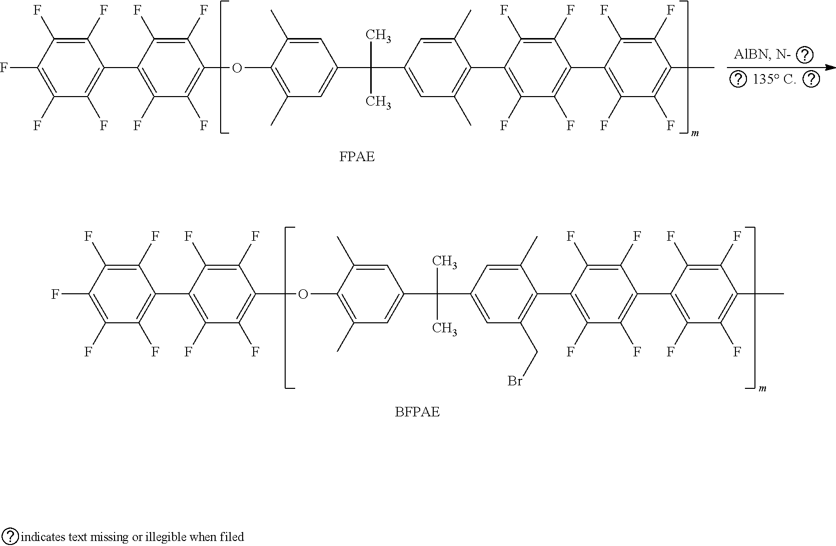

(1) FPAE according to each of Preparation Examples 1 to 3 and Comparative Preparation Example 1 was placed in a 2-neck flask.
(2) AIBN (azobisisobutyronitrile) and NBS (N-bromosuccinimide) were sequentially added thereto.
(3) The flask was connected to a condenser.
(4) Chlorobenzene was added thereto with stirring.
(5) Reaction was carried out for 6 hours under nitrogen purging at a temperature of 135° C.
(6) The result was precipitated in ethanol, filtered, and then dried to obtain BFPAE.

The amounts of components that were used and the properties of the product are shown in Table 2 below.

TABLE 2

| | | | | | | | Comparative | |
|---|---|---|---|---|---|---|---|---|
| | Preparation | | Preparation | | Preparation | | Preparation | |
| Items | Example 1 | | Example 2 | | Example 3 | | Example 1 | |
| FPAE [g(mmol)] | 3.0 | (5.19) | 5.0 | (8.65) | 1.0 | (1.73) | 5.0 | (8.65) |
| AIBN [g(mmol)] | 0.038 | (0.234) | 0.085 | (0.519) | 0.026 | (0.156) | 0.213 | (1.30) |
| NBS [g(mmol)] | 1.39 | (7.78) | 3.08 | (17.3) | 0.920 | (5.19) | 7.70 | (43.2) |

| | | | | |
|---|---|---|---|---|
| Chlorobenzene [g(mmol)] | 43 | 71 | 14 | 72 |
| Degree of bromination [%] | 28 | 41 | 60 | 86 |
| BFPAE weight [g] | 3.28 | 4.72 | 1.35 | 7.08 |
| BFPAE yield [%] | 96 | 77 | 100 | 96 |

In order to control the degree of bromination of BFPAE according to Preparation Examples 1 to 3 and Comparative Preparation Example 1, NBS, which is a bromine precursor, was added in different amounts. Specifically, in Preparation Example 1, Preparation Example 2, Preparation Example 3, and Comparative Preparation Example 1, the molar ratio of FPAE to NBS was set to 1:1.5, 1:2, 1:3, and 1:5.

### 3. Synthesis of Phosphoric-Acid-Containing Partially Fluorinated Poly(Arylene Ether) (FPAE-PN)

FPAE-PN represented by Chemical Formula 4 was synthesized through the following reaction mechanism using components in the amounts shown in Table 3 below.

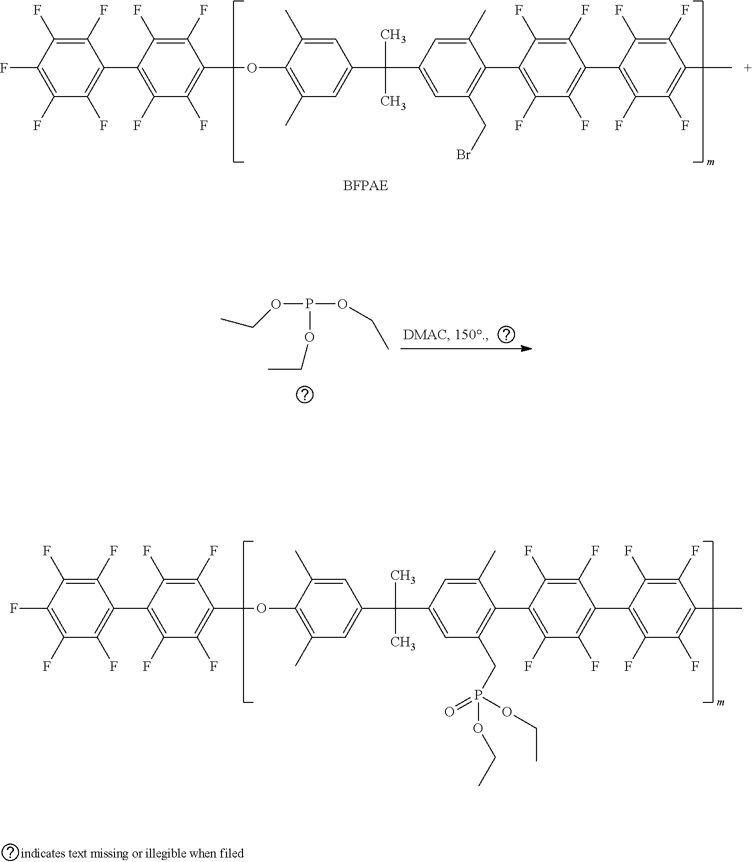

(1) BFPAE according to each of Preparation Examples 1 to 3 and Comparative Preparation Example 1 was placed in a 2-neck flask.
(2) DMAc was then added thereto.
(3) The flask was connected to a condenser.
(4) BFPAE was dissolved with stirring at a temperature of 150° C.
(5) Triethyl phosphite was added thereto after dissolution of BFPAE.
(6) Reaction was carried out for 16 hours with stirring at a temperature of 150° C.
(7) The result was precipitated in distilled water, filtered, and then dried to obtain FPAE-PN.

The amounts of components that were used and the properties of the product are shown in Table 3 below.

TABLE 3

| | | | | Comparative |
|---|---|---|---|---|
| | Preparation | Preparation | Preparation | Preparation |
| Items | Example 1 | Example 2 | Example 3 | Example 1 |
| BFPAE [g] | 4.19 | 5.16 | 1.31 | 5.01 |
| Degree of bromination [%] | 28 | 41 | 60 | 86 |
| Triethyl phosphite [ml(mmol)] | 6.05 (33.1) | 10.3 (59.9) | 6.23 (36.3) | 17.4 (102) |
| DMAc [ml] | 46.6 | 44.8 | 18.56 | 27.0 |
| FPAE-PN weight [g] | 3.91 | 4.18 | 1.40 | 3.30 |
| FPAE-PN yield [%] | 82 | 68 | 85 | 49 |

### 4. Synthesis of Phosphoric Partially Fluorinated Poly(Arylene Ether) (FPAE-PA)

FPAE-PA represented by Chemical Formula 3 was synthesized through the following reaction mechanism using components in the amounts shown in Table 4 below.

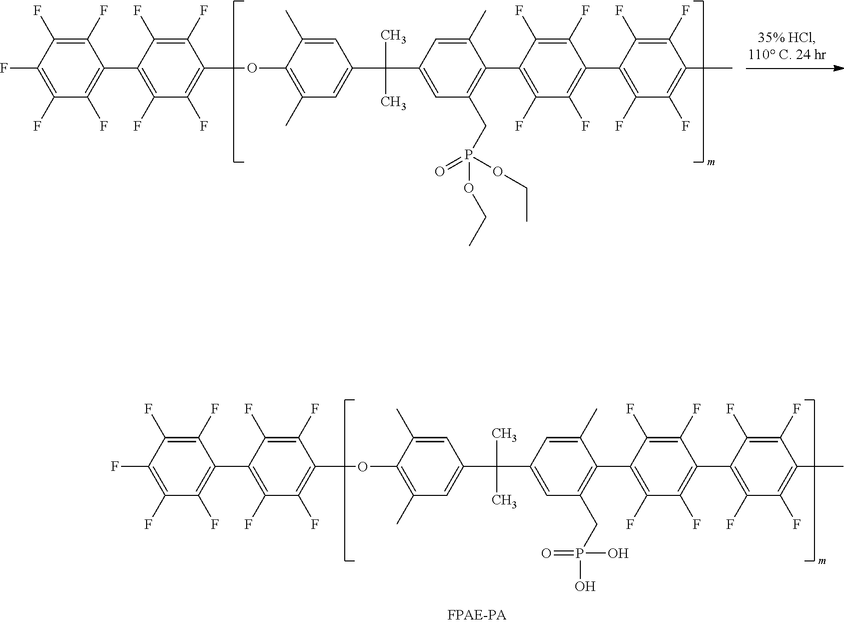

(1) FPAE-PN according to each of Preparation Examples 1 to 3 and Comparative Preparation Example 1 was placed in a 2-neck flask.
(2) The flask was connected to a condenser.
(3) A 35% aqueous HCl solution was added thereto and stirred.
(4) The temperature of an oil bath preheated to 80° C. was slowly raised to 110° C. in 5° C. increments, followed by reaction for 24 hours.
(5) The product was poured into distilled water and thus neutralized, filtered, and then dried to obtain FPAE-PA.

The amounts of components that were used and the properties of the product are shown in Table 4 below.

TABLE 4

| | | | | Comparative |
|---|---|---|---|---|
| | Preparation | Preparation | Preparation | Preparation |
| Items | Example 1 | Example 2 | Example 3 | Example 1 |
| FPAE-PN [g] | 3.91 | 4.10 | 1.38 | 3.15 |
| Degree of bromination [%] | 28 | 41 | 60 | 86 |
| HCl [ml] | 130 | 137 | 46 | 105 |
| FPAE-PA weight [g] | 3.37 | 3.37 | 1.12 | 2.30 |
| FPAE-PA yield [%] | 94 | 93 | 95 | 86 |

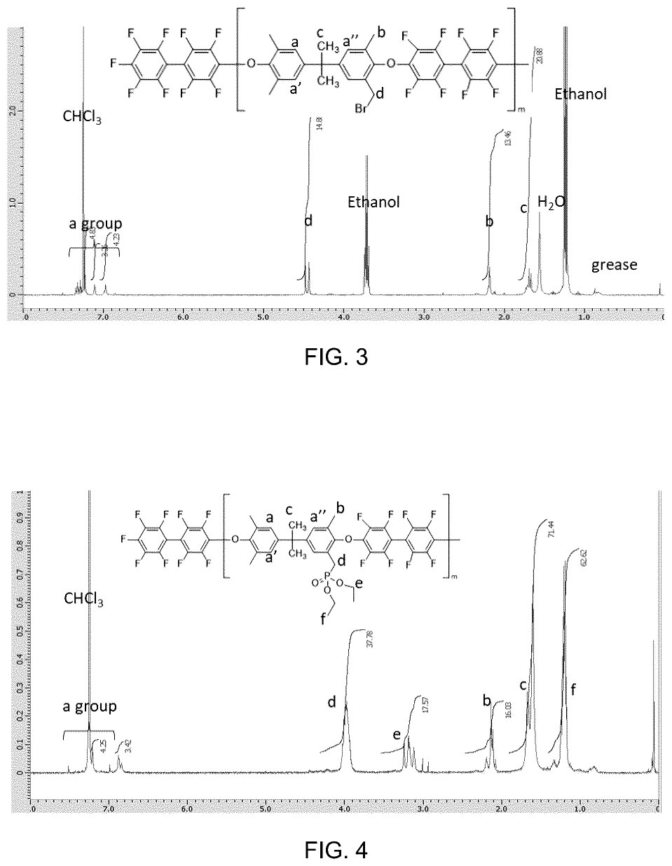

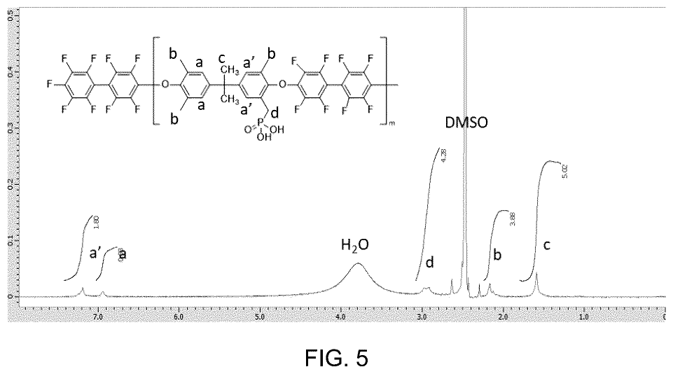

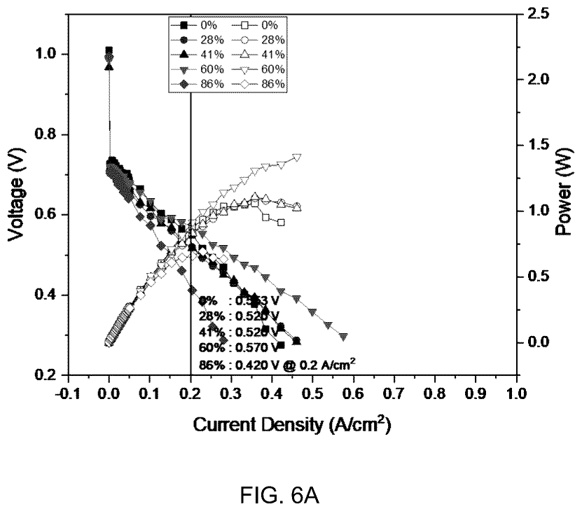

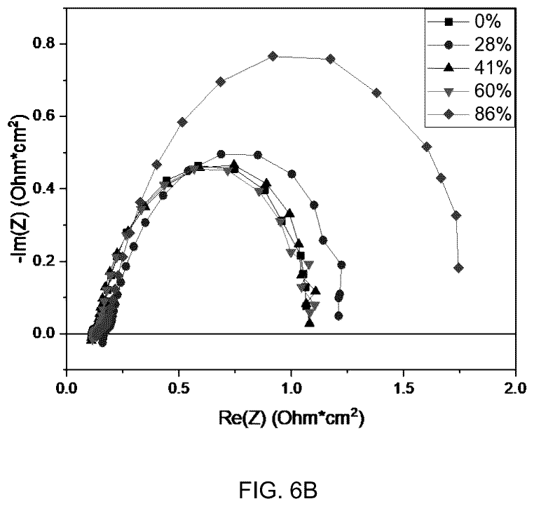

FIG. 2 shows results of NMR analysis of FPAE according to Preparation Example 3. FIG. 3 shows results of NMR analysis of BFPAE according to Preparation Example 3. FIG. 4 shows results of NMR analysis of FPAE-PN according to Preparation Example 3. FIG. 5 shows results of NMR analysis of FPAE-PA according to Preparation Example 3. Based on the results of NMR analysis, the degree of bromination of BFPAE according to Preparation Example 3 was determined to be about 60%. Also, bromine (Br) was substituted with a phosphorus (P)-containing functional group as described above, and thus the proportion of introduction of the phosphorus (P)-containing functional group in FPAE-PN and FPAE-PA according to Preparation Example 3 was 60%, which satisfies Relation 1.

### Examples 1 to 3 and Comparative Examples 1 and 2

The performance of the high-temperature polymer electrolyte membrane fuel cell depending on the proportion of introduction of the phosphorus (P)-containing functional group in FPAE-PN was evaluated.

In FPAE-PN according to Preparation Example 1, the proportion of introduction of the phosphorus (P)-containing functional group resulting from the degree of bromination was 28%. In FPAE-PN according to Preparation Example 2, the proportion of introduction of the phosphorus (P)-containing functional group was 41%. In FPAE-PN according to Preparation Example 3, the proportion of introduction of the phosphorus (P)-containing functional group was 60%. In FPAE-PN according to Comparative Preparation Example 1, the proportion of introduction of the phosphorus (P)-containing functional group was 86%.

Respective high-temperature polymer electrolyte membrane fuel cells were manufactured using FPAE-PN of Preparation Examples 1 to 3, FPAE without introducing a phosphorus (P)-containing functional group in the process of Comparative Preparation Example 1, and FPAE-PN of Comparative Preparation Example 1 as the ionomer for a cathode, and were set as Examples 1 5 to 3, Comparative Example 1, and Comparative Example 2.

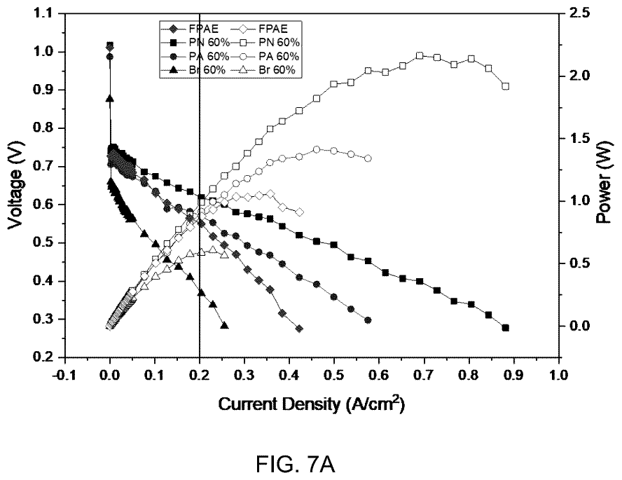

FIG. 6A shows a voltage-current density graph of the high-temperature polymer electrolyte membrane fuel cells according to Examples 1 to 3 and Comparative Examples 1 and 2. FIG. 6B is a Nyquist diagram showing the impedance results of the high-temperature polymer electrolyte membrane fuel cells according to Examples 1 to 3 and Comparative Examples 1 and 2.

Each item in FIGS. 6A and 6B is as follows.
0%: Comparative Example 1
28%: Example 1
41%: Example 2
60%: Example 3
86%: Comparative Example 2

With reference thereto, Comparative Examples 1 and 2 exhibited poor performance due to the solubility problem of the ionomer. All of Examples 1 to 3 showed greater performance than Comparative Examples 1 and 2, and in particular, Example 3, in which the proportion of introduction of the phosphorus (P)-containing functional group was 60%, exhibited the best performance.

### Examples 4 and 5 and Comparative Examples 3 and 4

Respective high-temperature polymer electrolyte membrane fuel cells were manufactured using FPAE, BFPAE, FPAE-PN, and FPAE-PA, which are the results of individual steps of Preparation Example 3, as the ionomer for a cathode, and were set as Comparative Example 3, Comparative Example 4, Example 4, and Example 5.

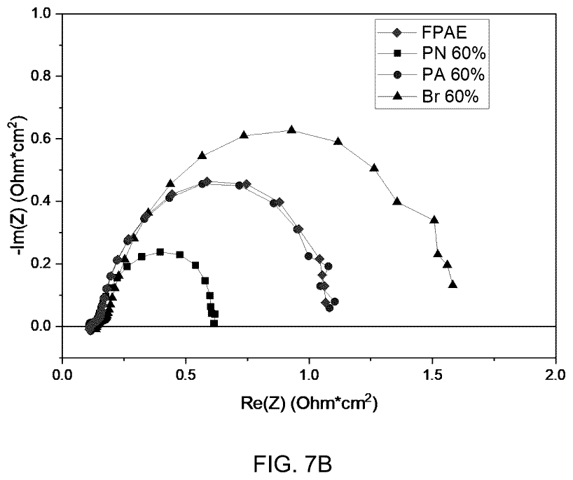

FIG. 7A shows a voltage-current density graph of the high-temperature polymer electrolyte membrane fuel cells according to Examples 4 and 5 and Comparative Examples 3 and 4. FIG. 7B is a Nyquist diagram showing the impedance results of the high-temperature polymer electrolyte membrane fuel cells according to Examples 4 and 5 and Comparative Examples 3 and 4.

Each item in FIGS. 7A and 7B is as follows.
FPAE: Comparative Example 3
PN 60%: Example 4
PA 60%: Example 5
Br 60%: Comparative Example 4

Comparative Example 4 using BFPAE showed very poor performance, which is considered to be due to poisoning of the platinum catalyst by bromine (Br). In contrast, Examples 4 and 5 exhibited vastly superior performance compared to Comparative Examples 3 and 4, and in particular, Example 4 including a phosphonate group as the phosphorus (P)-containing functional group showed the best results. This is because of proper balancing between hydrophobicity due to the introduction of fluorine (F) and hydrophilicity due to the introduction of the phosphorus (P)-containing functional group.

As is apparent from the above description, an ionomer according to various exemplary embodiments of the present disclosure is capable of reducing resistance to proton conduction in the cathode, thereby achieving an improvement in performance of a high-temperature polymer electrolyte membrane fuel cell.

The use of the ionomer according to various exemplary embodiments of the present disclosure enables proton conductivity to be maintained while decreasing the amount of a phosphoric acid electrolyte that is used.

Since fluorine (F) is introduced into the main chain of the ionomer according to various exemplary embodiments of the present disclosure, it is possible to solve problems at the cathode such as overflow of phosphoric acid electrolyte and generated water, catalyst poisoning, decreased activity, etc.

The effects of the present disclosure are not limited to the above-mentioned effects. It should be understood that the effects of the present disclosure include all effects that can be inferred from the description of the present disclosure.

Although specific embodiments of the present disclosure have been described through the test examples and examples above, these examples are not construed as limiting the scope of the present disclosure, and various modifications and improvements by those skilled in the art using the basic concept of the present disclosure as defined in the following claims are also included in the scope of the present disclosure.

What is claimed is:

1. An ionomer for a high-temperature polymer electrolyte membrane fuel cell, comprising a copolymer of
a first repeat unit represented by Chemical Formula 1 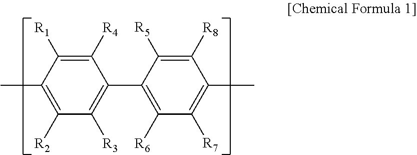
wherein each of R₁ to R₈ is independently hydrogen or fluorine (F); and
a second repeat unit represented by Chemical Formula 2 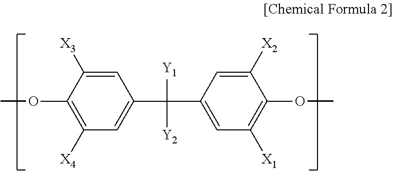
wherein each of X₁ to X₄ is independently hydrogen, an alkyl group having 1 to 4 carbon atoms, or a phosphorus (P)-containing functional group, and each of Y₁ and Y₂ is independently hydrogen or an alkyl group having 1 to 4 carbon atoms.

2. The ionomer of claim 1, wherein the copolymer is an alternating copolymer, a random copolymer, or a block copolymer.

3. The ionomer of claim 1, wherein the copolymer has a weight average molecular weight of about 30,000 g/mol to 100,000 g/mol.

4. The ionomer of claim 1, wherein the phosphorus (P)-containing functional group comprises a phosphate group, a phosphonate group, or any combination thereof.

5. The ionomer of claim 1, wherein the copolymer is represented by Chemical Formula 3 below: 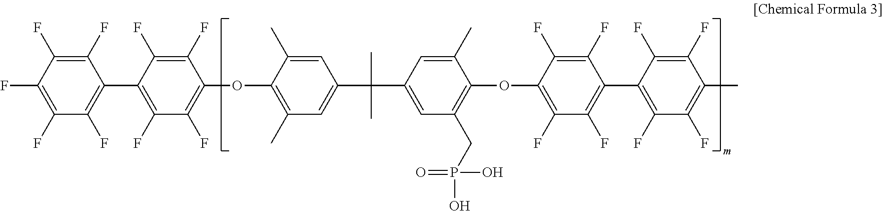
wherein m is an integer from 40 to 140.

6. The ionomer of claim 1, wherein the copolymer is represented by Chemical Formula 4 below: 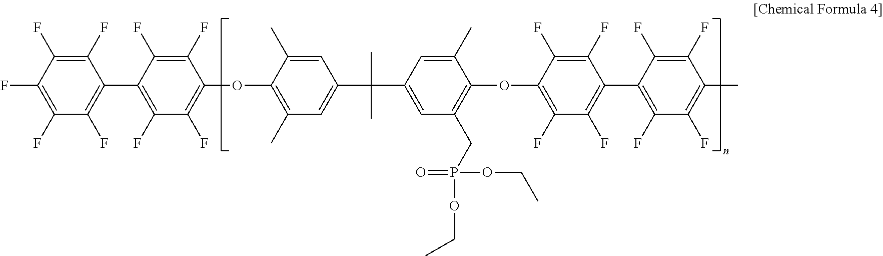
wherein n is an integer from 40 to 140.

7. The ionomer of claim 1, wherein the compound satisfies Relation 1 below.
$$28 \% \leq \frac{\begin{matrix}number of {X}_{1} to {X}_{4} \\ substituted with phosphorus \\ ( P ) - containing functional \\ group in copolymer\end{matrix}}{\begin{matrix}total number of \\ {X}_{1} to {X}_{4} contained \\ in copolymer\end{matrix}} \times 100 < 86 \% \qquad [ Relation 1 ]$$

8. A polymer electrolyte membrane fuel cell, comprising:
an electrolyte membrane;
a cathode disposed on one surface of the electrolyte membrane; and
an anode disposed on a remaining surface of the electrolyte membrane,
wherein the cathode comprises an ionomer of claim 1.

9. A method of preparing an ionomer for a polymer electrolyte membrane fuel cell, comprising:
preparing a first precursor compound represented by Chemical Formula 7 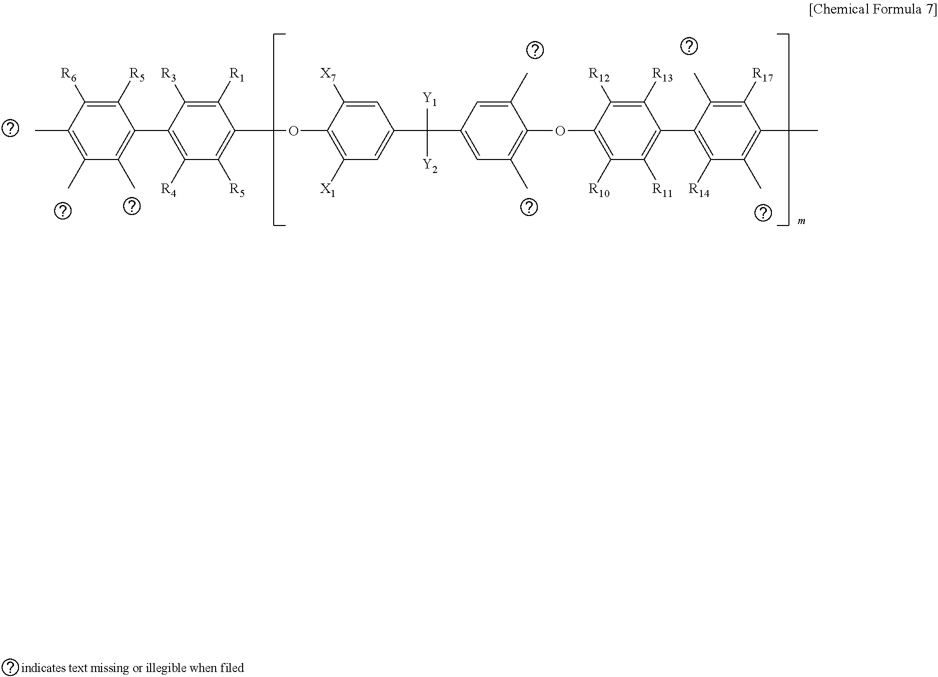
in Chemical Formula 7, each of R₁ to R₁₇ is independently hydrogen or fluorine (F), each of Y₁ and Y₂ is independently hydrogen or an alkyl group having 1 to 4 carbon atoms, each of X₅ to X₈ is independently hydrogen or an alkyl group having 1 to 4 carbon atoms, and m is an integer from 40 to 140;
preparing a second precursor compound in which at least one of X₅ to X₈ is substituted with elemental bromine by reacting the first precursor compound with a compound containing elemental bromine; and
substituting the elemental bromine with a phosphorus (P)-containing functional group by reacting the second precursor compound with a compound containing elemental phosphorus,
wherein the ionomer comprises a copolymer of a first repeat unit represented by Chemical Formula 1 below and a second repeat unit represented by Chemical Formula 2: 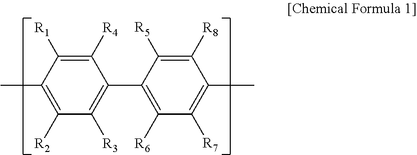
in Chemical Formula 1, each of R₁ to R₈ is independently hydrogen or fluorine (F); and 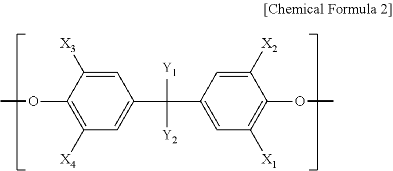
in Chemical Formula 2, each of X₁ to X₄ is independently hydrogen, an alkyl group having 1 to 4 carbon atoms, or a phosphorus (P)-containing functional group, and each of Y₁ and Y₂ is independently hydrogen or an alkyl group having 1 to 4 carbon atoms.

10. The method of claim 9, wherein the copolymer has a weight average molecular weight of about 30,000 g/mol to 100,000 g/mol.

11. The method of claim 9, wherein the compound containing elemental bromine comprises N-bromosuccinimide.

12. The method of claim 9, wherein the compound containing elemental phosphorus comprises triethyl phosphite.

13. The method of claim 9, wherein the phosphorus (P)-containing functional group comprises a phosphate group, a phosphonate group, or any combination thereof.

14. The method of claim 9, wherein the copolymer is represented by Chemical Formula 4 below: 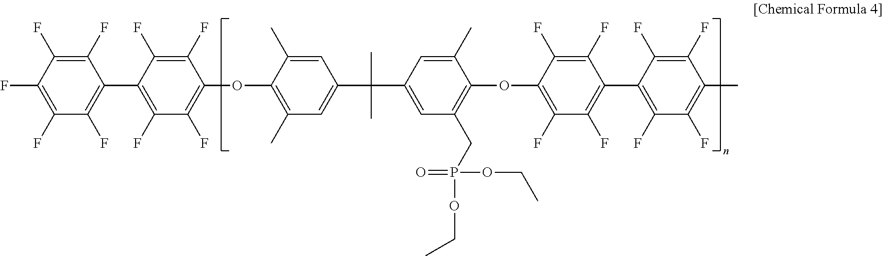
in Chemical Formula 4, n is an integer from 40 to 140.

15. The method of claim 14, wherein a copolymer represented by Chemical Formula 3 below is obtained by adding an acid solution to the copolymer represented by Chemical Formula 4 and then performing heat treatment: 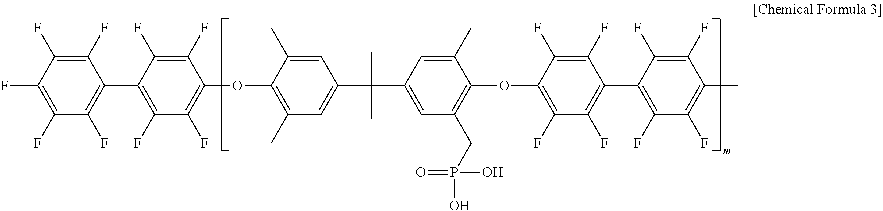
in Chemical Formula 3, m is an integer from 40 to 140.

16. The method of claim 9, wherein the copolymer satisfies Relation 1
$$28 \% \leq \frac{\begin{matrix}nmber of {X}_{1} to {X}_{4} \\ substituted with phosphorus \\ ( P ) - containing functional \\ group in copolymer\end{matrix}}{\begin{matrix}total number of \\ {X}_{1} to {X}_{4} contained \\ in copolymer\end{matrix}} \times 100 < 86 \% . \qquad [ Relation 1 ]$$

17. A vehicle comprising a fuel cell of claim 8.
